(19) United States
(12) Patent Application Publication
(10) Pub. No.: US 2026/0370902 A1
(43) Pub. Date: Nov. 19, 2026

(54) VIDEO PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Jiayu JI, Beijing (CN); Yimeng ZHANG, Beijing (CN); Ruiting CHEN, Beijing (CN); Xiangrui ZHENG, Beijing (CN)

(21) Appl. No.: 19/515,445

(22) PCT Filed: Aug. 28, 2024
(86) PCT No.: PCT/CN2024/115277

§ 371 Date: Feb. 27, 2026

(30) Foreign Application Priority Data
Aug. 31, 2023 (CN) 202311120475.X

(51) Int. Cl. H04N 21/431; H04N 21/488; H04N 21/81

(52) U.S. Cl. CPC H04N 21/4318; H04N 21/4884; H04N 21/8113; H04N 21/816

(57) ABSTRACT

The present disclosure relates to a video processing method and apparatus, an electronic device, and a storage medium. The method includes: displaying text data to be processed corresponding to a video to be processed, where the video to be processed includes a media video and a media audio; in response to a first trigger operation for target text data in the text data to be processed, determining a target video clip corresponding to the target text data from the media video based on the first mapping relationship; determining a target audio clip corresponding to the target text data from the media audio based on the second mapping relationship; and performing corresponding processing on the target text data, the target video clip, and the target audio clip based on the first trigger operation

The present application claims priority to Chinese Patent Application No. 202311120475.X, entitled “VIDEO PROCESSING METHOD AND APPARATUS, ELECTRONIC DEVICE, AND STORAGE MEDIUM”, filed with the China National Intellectual Property Administration on Aug. 31, 2023, which is hereby incorporated by reference in its entirety.

### TECHNICAL FIELD

The present disclosure relates to the field of video technologies, and in particular, to a video processing method and apparatus, an electronic device, a storage medium, and a program product.

### BACKGROUND

With the increasing richness of Internet information, watching videos has become an entertainment activity in people's daily life. In order to improve the user's viewing experience, editing a video before publishing various types of videos is an important step.

When creating a video, a creator may use a video editing tool to edit a shot video material. At present, most video editing tools mainly perform editing operations on a video frame, including dragging and dropping the video frame, sorting the video frame, switching a material, adding subtitles, etc., to implement a video editing process. However, the editing operations on the video frame require the creator to have certain video editing knowledge, and the creator cannot complete the video editing work quickly. Therefore, the editing operations on the video frame are complicated and time-consuming, affecting the use experience of the creator.

### SUMMARY

In order to solve the above technical problems or at least partially solve the above technical problems, the present disclosure provides a video processing method and apparatus, an electronic device, a storage medium, and a program product.

A first aspect of the embodiments of the present disclosure provides a video processing method, and the method includes: displaying text data to be processed corresponding to a video to be processed, where the video to be processed includes a media video and a media audio, and there is a first mapping relationship between text time code information corresponding to the text data to be processed and first timeline information corresponding to the media video, and there is a second mapping relationship between the text time code information and second timeline information corresponding to the media audio; in response to a first trigger operation for target text data in the text data to be processed, determining a target video clip corresponding to the target text data from the media video based on the first mapping relationship; determining a target audio clip corresponding to the target text data from the media audio based on the second mapping relationship; and performing corresponding processing on the target text data, the target video clip, and the target audio clip based on the first trigger operation.

In some embodiments of the present application, the video to be processed further includes at least one packaging object, and there is a mapping relationship between the text time code information and timeline information corresponding to each packaging object, where an object type of each packaging object includes at least one of the following: subtitle text, picture in picture, non-subtitle text, sticker, effect, filter, material package, and background music.

In some embodiments of the present application, the first trigger operation includes any of the following: a deleting operation, a dragging operation, a copying operation, and a cutting operation, and the method further includes: in response to the first trigger operation for the target text data in the text data to be processed, determining a target packaging object corresponding to the target text data from the at least one packaging object; and based on the first trigger operation, in a case that an object type of the target packaging object is any of a first type, performing corresponding processing on the target packaging object, and in a case that the object type of the target packaging object is any of a second type, prohibiting performing corresponding processing on the target packaging object, where the first type includes at least one of the following: subtitle text, picture in picture, non-subtitle text, sticker, effect, filter, and material package, and the second type includes: background music.

In some embodiments of the present application, the first type includes a third type and a fourth type, and in the case that the object type of the target packaging object is any of the first type, performing corresponding processing on the target packaging object includes: in a case that the object type of the target packaging object is any of the third type, performing corresponding processing on a target packaging clip in the target packaging object, where the target packaging clip is a part corresponding to the target text data in the target packaging object; or in a case that the object type of the target packaging object is any of the fourth type and a start time stamp of the target packaging object is within a time code range corresponding to the target text data, performing corresponding processing on the whole target packaging object, where the third type includes at least one of the following: subtitle text and picture in picture, and the fourth type includes at least one of the following: non-subtitle text, sticker, effect, filter, and material package.

In some embodiments of the present application, the method further includes: in the case that the object type of the target packaging object is any of the fourth type and the start time stamp of the target packaging object is not within the time code range corresponding to the target text data, prohibiting performing corresponding processing on the target packaging object.

In some embodiments of the present application, the method further includes: in response to a modifying operation for first text data in the text data to be processed, acquiring modified second text data corresponding to the modifying operation; determining a first audio clip corresponding to the first text data from the media audio based on the second mapping relationship; generating a second audio clip based on the second text data and tone information of the first audio clip; and replacing the first audio clip in the media audio with the second audio clip.

In some embodiments of the present application, the video to be processed further includes subtitle text, and there is a third mapping relationship between the text time code information and third timeline information corresponding to the subtitle text, and the method further includes: in response to the modifying operation for the first text data in the text data to be processed, determining a first subtitle clip corresponding to the first text data from the subtitle text based on the third mapping relationship; modifying the first subtitle clip based on the second text data to obtain a second subtitle clip; and replacing the first subtitle clip in the subtitle text with the second subtitle clip.

In some embodiments of the present application, the first trigger operation further includes a selecting operation, and before in response to the first trigger operation for the target text data in the text data to be processed, determining the target video clip corresponding to the target text data from the media video based on the first mapping relationship, the method further includes: displaying a first timeline track and a second timeline track, where the first timeline track is a timeline track corresponding to the media video, and the second timeline track is a timeline track corresponding to the media audio; and performing corresponding processing on the target text data, the target video clip, and the target audio clip based on the first trigger operation includes: displaying the target text data according to a first display style; displaying a part corresponding to the target video clip in the first timeline track according to a second display style; and displaying a part corresponding to the target audio clip in the second timeline track according to a third display style.

In some embodiments of the present application, the method further includes: in response to a second trigger operation for selected text data in the text data to be processed, displaying a tool menu in an area corresponding to the selected text data, where the tool menu includes at least one of the following: an editing control and an adding control, and the editing control includes at least one of the following: a deleting control corresponding to a deleting operation, a copying control corresponding to a copying operation, a cutting control corresponding to a cutting operation, and a modifying control corresponding to a modifying operation, an intelligent long and short sentence control, a searching control, and a replacing control, and the adding control includes at least one of the following: an adding picture in picture control, an adding non-subtitle text control, an adding sticker control, an adding effect control, an adding sound effect control, an adding filter control, an adding material package control, and an adding background music control; and in response to a third trigger operation for a target control in the tool menu, performing corresponding processing on at least one of the media video, the text data to be processed, and the media audio.

In some embodiments of the present application, after displaying the text data to be processed corresponding to the video to be processed, the method further includes: in response to a trigger operation for a material library control, displaying a plurality of preset video materials; in response to a fifth trigger operation for a target video material in the plurality of preset video materials, displaying a text rough cut floating window, where the text rough cut floating window includes material text data corresponding to the target video material, and the target video material includes a target material video and a target material audio, and there is a fourth mapping relationship between material time code information of the material text data and timeline information of the target material video, and there is a fifth mapping relationship between the material time code information and timeline information of the target material audio; and in response to a text rough cut operation for selected material text in the material text data, synthesizing the selected material text with the text data to be processed to obtain text data to be edited, synthesizing a material video clip with the media video to obtain a media video to be edited, and synthesizing a material audio clip with the media audio to obtain a media audio to be edited, to implement editing a video to be edited based on a text editing operation for the text data to be edited, where the material video clip is a video clip which is obtained from the target material video and corresponds to the selected material text based on the fourth mapping relationship, and the material audio clip is an audio clip which is obtained from the target material audio and corresponds to the selected material text based on the fifth mapping relationship, and the video to be edited includes the media video to be edited and the media audio to be edited.

A second aspect of the embodiments of the present disclosure provides a video processing apparatus, and the apparatus includes: a displaying module, configured to display text data to be processed corresponding to a video to be processed, where the video to be processed includes a media video and a media audio, and there is a first mapping relationship between text time code information corresponding to the text data to be processed and first timeline information corresponding to the media video, and there is a second mapping relationship between the text time code information and second timeline information corresponding to the media audio; a determining module, configured to, in response to a first trigger operation for target text data in the text data to be processed, determine a target video clip corresponding to the target text data from the media video based on the first mapping relationship; the determining module is further configured to determine a target audio clip corresponding to the target text data from the media audio based on the second mapping relationship; and a processing module, configured to perform corresponding processing on the target text data, the target video clip, and the target audio clip based on the first trigger operation.

In some embodiments of the present application, the video to be processed further includes at least one packaging object, and there is a mapping relationship between the text time code information and timeline information corresponding to each packaging object, where an object type of each packaging object includes at least one of the following: subtitle text, picture in picture, non-subtitle text, sticker, effect, filter, material package, and background music.

In some embodiments of the present application, the first trigger operation includes any of the following: a deleting operation, a dragging operation, a copying operation, and a cutting operation, and the determining module is further configured to, in response to the first trigger operation for the target text data in the text data to be processed, determine a target packaging object corresponding to the target text data from the at least one packaging object, and the processing module is further configured to, based on the first trigger operation, in a case that an object type of the target packaging object is any of a first type, perform corresponding processing on the target packaging object, and in a case that the object type of the target packaging object is any of a second type, prohibit performing corresponding processing on the target packaging object, where the first type includes at least one of the following: subtitle text, picture in picture, non-subtitle text, sticker, effect, filter, and material package, and the second type includes: background music.

In some embodiments of the present application, the first type includes a third type and a fourth type, and the processing module is further configured to, in a case that the object type of the target packaging object is any of the third type, perform corresponding processing on a target packaging clip in the target packaging object, where the target packaging clip is a part corresponding to the target text data in the target packaging object; or in a case that the object type of the target packaging object is any of the fourth type and a start time stamp of the target packaging object is within a time code range corresponding to the target text data, perform corresponding processing on the whole target packaging object, where the third type includes at least one of the following: subtitle text and picture in picture, and the fourth type includes at least one of the following: non-subtitle text, sticker, effect, filter, and material package.

In some embodiments of the present application, the processing module is further configured to: in the case that the object type of the target packaging object is any of the fourth type and the start time stamp of the target packaging object is not within the time code range corresponding to the target text data, prohibit performing corresponding processing on the target packaging object.

In some embodiments of the present application, the apparatus further includes: an acquiring module, a generating module, and a replacing module, and the acquiring module is configured to, in response to a modifying operation for first text data in the text data to be processed, acquire modified second text data corresponding to the modifying operation, and the determining module is further configured to determine a first audio clip corresponding to the first text data from the media audio based on the second mapping relationship, and the generating module is configured to generate a second audio clip based on the second text data and tone information of the first audio clip, and the replacing module is configured to replace the first audio clip in the media audio with the second audio clip.

In some embodiments of the present application, the video to be processed further includes subtitle text, and there is a third mapping relationship between the text time code information and third timeline information corresponding to the subtitle text, and the apparatus further includes: a modifying module and a replacing module, and the determining module is further configured to, in response to the modifying operation for the first text data in the text data to be processed, determine a first subtitle clip corresponding to the first text data from the subtitle text based on the third mapping relationship, and the modifying module is configured to modify the first subtitle clip based on the second text data to obtain a second subtitle clip, and the replacing module is configured to replace the first subtitle clip in the subtitle text with the second subtitle clip.

In some embodiments of the present application, the first trigger operation further includes a selecting operation, and the displaying module is further configured to, before in response to the first trigger operation for the target text data in the text data to be processed, determining the target video clip corresponding to the target text data from the media video based on the first mapping relationship, display a first timeline track and a second timeline track, where the first timeline track is a timeline track corresponding to the media video, and the second timeline track is a timeline track corresponding to the media audio, and the processing module is further configured to display the target text data according to a first display style, display a part corresponding to the target video clip in the first timeline track according to a second display style, and display a part corresponding to the target audio clip in the second timeline track according to a third display style.

In some embodiments of the present application, the displaying module is further configured to, in response to a second trigger operation for selected text data in the text data to be processed, display a tool menu in an area corresponding to the selected text data, where the tool menu includes at least one of the following: an editing control and an adding control, and the editing control includes at least one of the following: a deleting control corresponding to a deleting operation, a copying control corresponding to a copying operation, a cutting control corresponding to a cutting operation, and a modifying control corresponding to a modifying operation, an intelligent long and short sentence control, a searching control, and a replacing control, and the adding control includes at least one of the following: an adding picture in picture control, an adding non-subtitle text control, an adding sticker control, an adding effect control, an adding sound effect control, an adding filter control, an adding material package control, and an adding background music control, and the processing module is further configured to, in response to a third trigger operation for a target control in the tool menu, perform corresponding processing on at least one of the media video, the text data to be processed, and the media audio.

In some embodiments of the present application, the displaying module is configured to, after displaying the text data to be processed corresponding to the video to be processed, in response to a trigger operation for a material library control, display a plurality of preset video materials, and in response to a fifth trigger operation for a target video material in the plurality of preset video materials, display a text rough cut floating window, where the text rough cut floating window includes material text data corresponding to the target video material, and the target video material includes a target material video and a target material audio, and there is a fourth mapping relationship between material time code information of the material text data and timeline information of the target material video, and there is a fifth mapping relationship between the material time code information and timeline information of the target material audio, and in response to a text rough cut operation for selected material text in the material text data, synthesize the selected material text with the text data to be processed to obtain text data to be edited, synthesize a material video clip with the media video to obtain a media video to be edited, and synthesize a material audio clip with the media audio to obtain a media audio to be edited, to implement editing a video to be edited based on a text editing operation for the text data to be edited, where the material video clip is a video clip which is obtained from the target material video and corresponds to the selected material text based on the fourth mapping relationship, and the material audio clip is an audio clip which is obtained from the target material audio and corresponds to the selected material text based on the fifth mapping relationship, and the video to be edited includes the media video to be edited and the media audio to be edited.

A third aspect of the embodiments of the present disclosure provides an electronic device, and the electronic device includes a processor, a memory, and a computer program stored on the memory and executable on the processor, and when the computer program is executed by the processor, the video processing method according to the first aspect is implemented.

A fourth aspect of the embodiments of the present disclosure provides a computer-readable storage medium, and a computer program is stored on the computer-readable storage medium, and when the computer program is executed by a processor, the video processing method according to the first aspect is implemented.

A fifth aspect of the embodiments of the present disclosure provides a computer program product, and the computer program product includes a computer program, and when the computer program product runs on a processor, the processor is caused to execute the computer program to implement the video processing method according to the first aspect.

A sixth aspect of the embodiments of the present disclosure provides a chip, and the chip includes a processor and a communication interface, and the communication interface is coupled with the processor, and the processor is configured to run program instructions to implement the video processing method according to the first aspect.

### BRIEF DESCRIPTION OF THE DRAWINGS

The drawings herein, which are incorporated in and constitute a part of this specification, illustrate embodiments consistent with the present disclosure and, together with the description, serve to explain the principles of the present disclosure.

In order to more clearly explain the technical solutions in the embodiments of the present disclosure or in the prior art, the drawings that need to be used in the description of the embodiments or the prior art will be briefly introduced below. Obviously, for those of ordinary skill in the art, they may also obtain other drawings according to these drawings without making creative efforts.

FIG. 1 is a first flowchart of a video processing method provided by an embodiment of the present disclosure;

FIG. 2 is a second flowchart of a video processing method provided by an embodiment of the present disclosure;

FIG. 3 is a first interface schematic diagram of a video processing method provided by an embodiment of the present disclosure;

FIG. 4 is a second interface schematic diagram of a video processing method provided by an embodiment of the present disclosure;

FIG. 5 is a third interface schematic diagram of a video processing method provided by an embodiment of the present disclosure;

FIG. 6 is a structural block diagram of a video processing apparatus provided by an embodiment of the present disclosure; and

FIG. 7 is a structural block diagram of an electronic device provided by an embodiment of the present disclosure.

### DETAILED DESCRIPTION OF EMBODIMENTS

In order to understand the above objects, features and advantages of the present disclosure more clearly, the solutions of the present disclosure will be further described below. It should be noted that, in case of no conflict, the features in one embodiment or in different embodiments may be combined.

Many specific details are set forth in the following description to facilitate a full understanding of the present disclosure, but the present disclosure may also be implemented in other ways different from those described herein. Obviously, the described embodiments are part of the embodiments of the present disclosure, but not all of the embodiments.

The terms “first”, “second” and the like in the description and claims of the present disclosure are used to distinguish similar objects, but not to describe a specific order or sequence. It should be understood that the data termed in such a way are interchangeable under appropriate circumstances so that the embodiments of the present disclosure described herein may be implemented in orders except the order illustrated or described herein. Moreover, the objects distinguished by “first”, “second” and the like are generally of one kind, and the number of objects is not limited. For example, the first object may be one or more. In addition, “and/or” in the specification and claims represents at least one of the connected objects, and the character “/”, generally represents that the associated objects before and after are in an “or” relationship.

The electronic device in the embodiments of the present disclosure may be a mobile electronic device or a non-mobile electronic device. The mobile electronic device may be a mobile phone, a tablet computer, a laptop computer, a palmtop computer, a vehicle electronic device, a wearable device, an ultra-mobile personal computer (UMPC), a netbook, or a personal digital assistant (PDA), etc. The non-mobile electronic device may be a personal computer (PC), a television (TV), a teller machine or a self-service machine, etc. The embodiments of the present disclosure are not specifically limited.

The execution body of the video processing method provided by the embodiments of the present disclosure may be the above electronic device (including the mobile electronic device and the non-mobile electronic device), or may be a functional module and/or a functional entity in the electronic device that may implement the video processing method, which may be specifically determined according to actual use requirements, and is not limited in the embodiments of the present disclosure.

The video processing method provided by the embodiments of the present disclosure will be described in detail below with reference to the drawings and through specific embodiments and application scenarios.

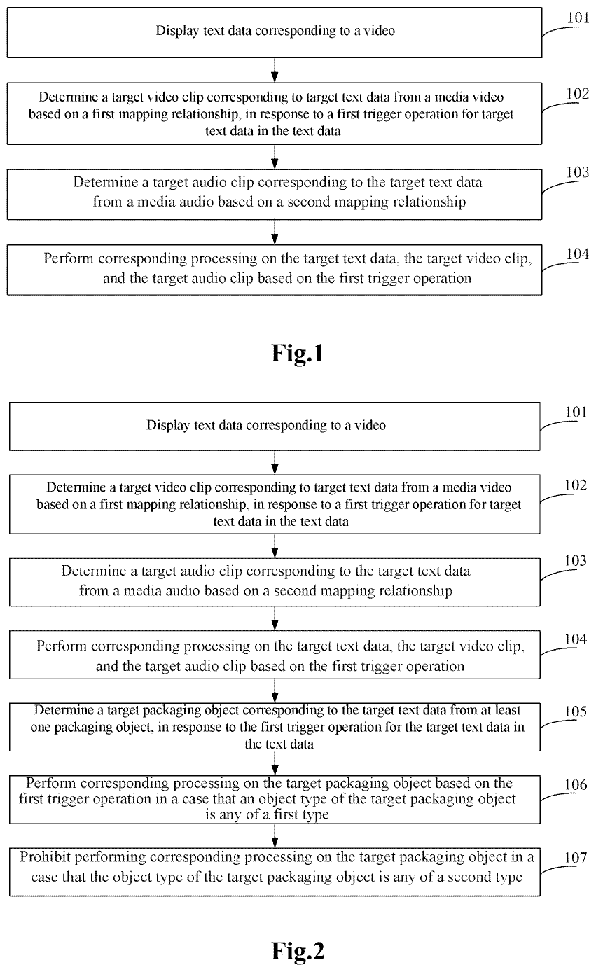

As shown in FIG. 1, an embodiment of the present disclosure provides a video processing method, and the method may include the following steps 101 to 104.

101, text data to be processed corresponding to a video to be processed is displayed.

The video to be processed includes a media video and a media audio, and there is a first mapping relationship between text time code information corresponding to the text data to be processed and first timeline information corresponding to the media video, and there is a second mapping relationship between the text time code information and second timeline information corresponding to the media audio.

The text time code information includes a time stamp corresponding to each semantic character in the text data to be processed, and the first timeline information includes a time stamp of each video frame of the media video. The first mapping relationship is a correspondence between the time stamp of each semantic character in the text data to be processed and the time stamp of each video frame of the media video frame. Exemplarily, the time stamp of one semantic character in the text data to be processed may correspond to the time stamp of one video frame (that is, the time stamps of the semantic characters in the text data to be processed are in one-to-one correspondence with the time stamps of the video frames in the media video), or the time stamp of one semantic character in the text data to be processed may correspond to the time stamps of multiple video frames.

The semantic character refers to a character with an independent semantics, for example, in Chinese, one semantic character refers to one Chinese character, and in English, one semantic character refers to one word.

The second timeline information includes a time stamp of each audio frame in the media audio. The second mapping relationship is a correspondence between the time stamp of each semantic character in the text data to be processed and the time stamp of each audio frame of the media audio. Exemplarily, the time stamp of one semantic character in the text data to be processed may correspond to the time stamp of one audio frame (that is, the time stamps of the semantic characters in the text data to be processed are in one-to-one correspondence with the time stamps of the audio frames in the media audio), or the time stamp of one semantic character in the text data to be processed may correspond to the time stamps of multiple audio frames.

It may be understood that based on the first mapping relationship, it is possible to determine at least one video frame corresponding to any semantic character in the text data to be processed from the media video, and it is also possible to determine multiple video frames corresponding to any multiple semantic characters in the text data to be processed from the media video.

It may be understood that based on the second mapping relationship, it is possible to determine at least one audio frame corresponding to any semantic character in the text data to be processed from the media audio, and it is also possible to determine multiple audio frames corresponding to any multiple semantic characters in the text data to be processed from the media audio.

In the embodiments of the present application, the video to be processed includes, but is not limited to, a recorded video, a video obtained based on a script, etc. The text data to be processed may be obtained by performing speech recognition on the media audio or the video to be processed, or may be a script. In the case that the text data to be processed is a script, the text data to be processed may be matched with the media video to obtain the first mapping relationship between the text data to be processed and a video time stamp of the media video. The speech recognition method includes, but is not limited to, an automatic speech recognition (ASR) technology.

In some embodiments of the present application, in the case that the text data to be processed is a script, the text data to be processed may be matched with the media audio to obtain the second mapping relationship between the text data to be processed and an audio time stamp of the media audio, or the second mapping relationship may be acquired according to a mapping relationship between the video time stamp of the media video and the audio time stamp of the media audio and the first mapping relationship, which may be specifically determined according to an actual situation, and is not limited here.

In some embodiments of the present application, a text editing panel may be invoked in response to a trigger operation for a text editing control in an interface where the video to be processed is displayed, and at the same time, the media video and the media audio of the video to be processed are extracted, and then the speech recognition is performed on the media audio to obtain the text data to be processed, and the text data to be processed is displayed in the text editing panel, and at the same time, the first mapping relationship and the second mapping relationship are acquired.

In some embodiments of the present application, while displaying the text data to be processed in the text editing panel, it is also possible to display at least one of the video to be processed, a first timeline track corresponding to the media video, a second timeline track corresponding to the media audio, a text editing menu, and a global function menu.

The text editing menu may include at least one of the following: a deleting control corresponding to a deleting operation, a copying control corresponding to a copying operation, a cutting control corresponding to a cutting operation, and a modifying control corresponding to a modifying operation, an intelligent long and short sentence control (intelligent long and short sentence replacing control), a replacing control, an adding picture in picture control, an adding non-subtitle text control, an adding sticker control, an adding effect control, an adding sound effect control, an adding filter control, an adding material package control, and an adding background music control.

The global function menu includes at least one of the following: a searching control, a filler word removing control, and a subtitle switch control.

The filler word removing control is used to instruct filler word removing processing, and the filler word removing processing refers to removing meaningless words, modal particles, mute clips and other invalid words or clips in the text data to be processed, so as to ensure semantic coherence of the text data to be processed after the filler word removing processing.

In some embodiments of the present application, the text editing panel further includes an exit control, and the text editing panel is folded up (exited) in response to a trigger operation for the exit control.

In some embodiments of the present application, if ASR recognition is still being performed on the media audio when exiting the text editing panel, the recognition is not interrupted and continues in the background.

In the present embodiment, the text data to be processed may be displayed on an interface, and then the editing processing of the video to be processed is implemented through the editing processing of the text data to be processed.

102, in response to a first trigger operation for target text data in the text data to be processed, a target video clip corresponding to the target text data is determined from the media video based on the first mapping relationship.

The first trigger operation may be a click operation, a slide operation, a drag operation, etc., which may be specifically determined according to an actual situation, and is not limited here.

It may be understood that a time stamp of the target video clip corresponds to a time stamp of the target text data.

103, a target audio clip corresponding to the target text data is determined from the media audio based on the second mapping relationship.

It may be understood that a time stamp of the target audio clip corresponds to the time stamp of the target text data.

104, corresponding processing is performed on the target text data, the target video clip, and the target audio clip based on the first trigger operation.

It may be understood that based on the first trigger operation, processing corresponding to the first trigger operation is performed on the target text data, the target video clip, and the target audio clip.

In the embodiments of the present application, based on the first mapping relationship and the second mapping relationship, the corresponding processing is performed on the text data to be processed through the first trigger operation, so as to implement the corresponding processing on the media video and the media audio, and then implement the editing processing on the video to be processed. Compared with the editing operation of the video frame, the editing operation of the text data is relatively simple, and the professional requirements for the creator are relatively low, so that the editing efficiency of the video to be processed may be improved, and the use experience of the creator may be improved.

In some embodiments of the present application, the video to be processed further includes at least one packaging object, and there is a mapping relationship between the text time code information and timeline information corresponding to each packaging object, where an object type of each packaging object includes at least one of the following: subtitle text, picture in picture, non-subtitle text, sticker, effect, filter, material package, and background music.

The packaging object may correspond to the complete text data to be processed (for example, the packaging object is the background music, the subtitle text, the picture in picture, etc.), or the packaging object may correspond to part of text data in the text data to be processed (for example, the packaging object is the sticker, the effect, the filter, etc.), which may be specifically determined according to the actual situation, and is not limited here.

Taking at least one packaging object including a packaging object 1 and a packaging object 2 as an example, there is a mapping relationship 1 between the text time code information and timeline information corresponding to the packaging object 1, and there is a mapping relationship 2 between the text time code information and timeline information corresponding to the packaging object 2.

The subtitle text is text corresponding to content of the video to be processed and content of the media audio. The non-subtitle text is text other than the subtitle text.

The picture in picture is a video content presentation mode, which refers to that while one video is broadcast in full screen, another video is broadcast simultaneously in a small area of the picture, and it is widely used in televisions, video recorders, monitors, demonstration devices, etc.

The sticker may include text, pictures, images, etc.

The effect may include a visual effect, an audio effect (sound effect for short), etc.

The filter is mainly used to implement various special effects of an image, which may specifically refer to related prior art.

The material package is like a pre-assembled small template, which contains elements such as pictures, subtitles, and effects, and supports one-click addition, and the elements in the material package may be changed according to needs after the addition.

The background music is also called accompaniment music and soundtrack music, and it is usually a kind of music used to regulate atmosphere in a TV play, a movie, an animation, a video game and a website, which is inserted in dialogues and may enhance emotional expression to achieve an immersive experience for the audience. In the embodiments of the present application, the background music is audio content different from the media audio and the sound effect.

In the embodiments of the present application, the video to be processed includes at least one packaging object, and there is a mapping relationship between timeline information of each packaging object and the text time code information of the text data to be processed, therefore, in a process of performing an editing operation on part of text data in the text data to be processed, it may be necessary to perform corresponding processing on a packaging object matching with the part of text data. In the embodiments of the present application, the media video, the media music, the at least one packaging object and the like in the video to be processed are extracted separately, and then, based on the editing operation on the text data to be processed, the corresponding operation is performed on at least one of the media video, the media music, and the at least one packaging object, so as to implement editing the video to be processed. Compared with editing the whole video to be processed based on the editing of the text data to be processed, the editing of the video to be processed is more detailed and reasonable, and the operation by the user is simple and easy to understand, thus improving the user experience.

In some embodiments of the present application, the first trigger operation includes any of the following: a deleting operation, a dragging operation, a copying operation, and a cutting operation, and the first trigger operation may further include other operations, which is not limited here. In the embodiments of the present application, the first trigger operation may support multiple editing operations, and the operation by the user is simple and easy to understand, thus improving the user experience.

Compared with the prior art, the technical solutions provided by the embodiments of the present disclosure have the following advantages: displaying text data to be processed corresponding to a video to be processed, where the video to be processed includes a media video and a media audio, and there is a first mapping relationship between text time code information corresponding to the text data to be processed and first timeline information corresponding to the media video, and there is a second mapping relationship between the text time code information and second timeline information corresponding to the media audio; in response to a first trigger operation for target text data in the text data to be processed, determining a target video clip corresponding to the target text data from the media video based on the first mapping relationship; determining a target audio clip corresponding to the target text data from the media audio based on the second mapping relationship; and performing corresponding processing on the target text data, the target video clip, and the target audio clip based on the first trigger operation. In the embodiments of the present application, based on the first mapping relationship and the second mapping relationship, the corresponding processing is performed on the text data to be processed through the first trigger operation, so as to implement the corresponding processing on the media video and the media audio, and then implement the editing processing on the video to be processed. Compared with the editing operation of the video frame, the editing operation of the text data is relatively simple, and the professional requirements for the creator are relatively low, so that the editing efficiency of the video to be processed may be improved, and the use experience of the creator may be improved.

In some embodiments of the present application, referring to FIG. 1 and FIG. 2, after the above step 101, the video processing method provided by the embodiments of the present application may further include the following steps 105 to 107.

105, in response to the first trigger operation for the target text data in the text data to be processed, a target packaging object corresponding to the target text data is determined from the at least one packaging object.

It may be understood that the target packaging object is a packaging object whose time stamp coincides with a time stamp of the target text data in the at least one packaging object.

106, based on the first trigger operation, in a case that an object type of the target packaging object is any of a first type, corresponding processing on the target packaging object is performed.

The first type includes at least one of the following: subtitle text, picture in picture, non-subtitle text, sticker, effect, filter, and material package.

107, in a case that the object type of the target packaging object is any of a second type, performing corresponding processing on the target packaging object is prohibited.

The second type includes: background music.

It may be understood that in the embodiments of the present application, the types of the packaging objects are distinguished, and some types of packaging objects are linked with the editing of the target text data, while some types of packaging objects do not respond to the editing operation of the target text data. In this way, whether to perform linked editing on the packaging object may be determined according to the type of the packaging object.

It may be understood that in the case that the type of the packaging object is the background music, if linked editing is performed with the target text data, the background music may be discontinuous, repeated, etc., and may no longer enhance emotions and allow the audience to have an immersive experience.

In some embodiments of the present application, the first type includes a third type and a fourth type, and the above step 106 may be implemented specifically through the following step 106a or step 106b.

106a, in a case that the object type of the target packaging object is any of the third type, corresponding processing is performed on a target packaging clip in the target packaging object, where the target packaging clip is a part corresponding to the target text data in the target packaging object.

The third type includes at least one of the following: subtitle text and picture in picture.

In the embodiments of the present application, the packaging objects of the subtitle text and the picture in picture type (third type) are generally in one-to-one correspondence with the media video, and therefore, the linked editing with the target text data may be performed.

106b, in a case that the object type of the target packaging object is any of the fourth type and a start time stamp of the target packaging object is within a time code range corresponding to the target text data, corresponding processing is performed on the whole target packaging object.

The time code range is a time range from a time code (time stamp) corresponding to a first semantic character in the target text data to a time code corresponding to a last semantic character in the target text data.

It may be understood that the start time stamp of the target packaging object being within the time code range corresponding to the target text data means that the start time stamp of the target packaging object is the same as a certain time stamp in the time code range.

The fourth type includes at least one of the following: non-subtitle text, sticker, effect, filter, and material package.

In the embodiments of the present application, the packaging objects of the non-subtitle text, the sticker, the effect, the filter and the material package type (fourth type) usually only correspond to a part of the media video, and if there is no determination on whether to perform linked editing with the target text data, and the linkage with the target text data is directly performed, it may lead to phenomena such as the incoherence of the packaging object and one packaging object becoming multiple packaging objects, thus losing the original effect of the packaging object and instead adding a bad effect. Therefore, in the embodiments of the present application, in the case that the object type of the target packaging object is any of the fourth type and the start time stamp of the target packaging object is within the time code range corresponding to the target text data, the corresponding processing is performed on the whole target packaging object, that is, in the case that it is determined to perform linked editing with the target text data, the corresponding processing is performed on the whole packaging object, so that it may be ensured that in the case that it is determined to perform linked editing with the target text data, the corresponding processing is performed on the whole packaging object, and no bad effect is added.

In some embodiments of the present application, after the above step 105, the video processing method provided by the embodiments of the present application may further include the following step 108.

108, in the case that the object type of the target packaging object is any of the fourth type and the start time stamp of the target packaging object is not within the time code range corresponding to the target text data, performing corresponding processing on the target packaging object is prohibited.

It may be understood that in the case that the object type of the target packaging object is any of the fourth type and the start time stamp of the target packaging object is not within the time code range corresponding to the target text data, the corresponding processing on the target packaging object is prohibited, that is, it is determined not to respond to the linked editing with the target text data (not to perform linked editing with the target text data), so that it may be ensured that the packaging object still has the original effect.

In the embodiments of the present application, the modifying operation acts on the text data to be processed and the media audio, and if there is subtitle text, the subtitle text is also linked, but the modifying operation does not act on the media video. That is, under normal circumstances, for the modifying operation, the linked editing is performed on the media audio and the text data to be processed, and if the video to be processed includes the subtitle text, the linked editing is performed on the subtitle text and the text data to be processed, while the linked editing is not performed on the media video and the text data to be processed. In this way, when the text data to be processed is modified, the media audio and the subtitle text are modified accordingly, but there is no need to modify the media video, which makes the logic simple, conforms to the actual situation, and provides a better user experience.

In some embodiments of the present application, after the above step 101, the video processing method provided by the embodiments of the present application may further include the following steps 109 to 112.

109, in response to a modifying operation for first text data in the text data to be processed, modified second text data corresponding to the modifying operation is acquired.

110, a first audio clip corresponding to the first text data is determined from the media audio based on the second mapping relationship.

111, a second audio clip is generated based on the second text data and tone information of the first audio clip.

In the embodiments of the present application, the second audio clip is generated based on the second text data and the tone information of the first audio clip, which may ensure that the content of the second audio clip corresponds to the second text data, and may also ensure that the tone information of the second audio clip is the same as the tone information of the first audio clip. In this way, not only the media audio is modified accordingly relative to the modification of the text data to be processed, but also the tone information of the modification position in the media audio is ensured not to change, thus improving the user experience.

112, the first audio clip in the media audio is replaced with the second audio clip.

It may be understood that the first audio clip in the media audio is replaced with the second audio clip, thus implementing the linkage modification of the media audio and the first text data.

In some embodiments of the present application, the video to be processed further includes subtitle text, and there is a third mapping relationship between the text time code information and third timeline information corresponding to the subtitle text, and after the above step 109, the video processing method provided by the embodiments of the present application may further include the following steps 113 to 115.

113, in response to the modifying operation for the first text data in the text data to be processed, a first subtitle clip corresponding to the first text data is determined from the subtitle text based on the third mapping relationship.

114, the first subtitle clip is modified based on the second text data to obtain a second subtitle clip.

It may be understood that the second subtitle clip corresponds to the second text data, and the second audio clip also corresponds to the second text data, therefore, the second subtitle clip also corresponds to the second audio clip, so that the situation of the subtitle not corresponding to the audio does not occur when the audience watches the video.

115, the first subtitle clip in the subtitle text is replaced with the second subtitle clip.

It may be understood that the first subtitle clip in the subtitle text is replaced with the second subtitle clip, thus implementing the linkage modification of the subtitle text and the first text data.

In some embodiments of the present application, in the case that the timeline track of the media video and the timeline track of the media audio are not displayed, the selecting operation is only for the text data, and the selected text data is selected and displayed.

In some embodiments of the present application, in the case that the timeline track of the media video and the timeline track of the media audio are displayed, the selecting operation is to select and display the selected text data, select and display a part of track corresponding to the selected text data in the timeline track of the media video, and select and display a part of track corresponding to the selected text data in the timeline track of the media audio. In this way, a better visual experience may be provided for the user, so that the user may understand how the corresponding video editing process is implemented.

In some embodiments of the present application, the first trigger operation further includes a selecting operation, and before the above step 102, the video processing method provided by the embodiments of the present application may further include the following step 116, and the above step 104 may be implemented specifically through the following steps 104a to 104c.

116, a first timeline track and a second timeline track are displayed.

The first timeline track is a timeline track corresponding to the media video, and the second timeline track is a timeline track corresponding to the media audio.

104a, the target text data is displayed according to a first display style.

104b, a part corresponding to the target video clip in the first timeline track is displayed according to a second display style.

104c, a part corresponding to the target audio clip in the second timeline track is displayed according to a third display style.

The first display style, the second display style, and the third display style may be partially the same, or partially different, or may be all the same, or all different, which is not limited here.

In some embodiments of the present application, in the case that the timeline track of each packaging object is displayed in addition to the timeline track of the media video and the timeline track of the media audio, whether to select and display the timeline track of the packaging object is determined according to the type of the packaging object and whether the start time stamp of the packaging object is within the time code range corresponding to the selected text data.

The track linkage logic during editing in the embodiments of the present application (specifically corresponding to whether the above media video, media audio, and packaging object are subjected to linked editing with the target text data) includes:
first determining a start time code and an end time code of the selected text to determine a target time code range of the selected text;
performing corresponding selection display on track parts corresponding to the target time code range in the timeline track of the media video, the timeline track of the media audio, the timeline track of the picture in picture, and the timeline track of the text subtitle respectively, and responding to subsequent editing operations such as deleting, moving, and copying;
if the start time stamp in the timeline track of the non-text subtitle, the timeline track corresponding to the sticker, etc. is within the target time code range, performing corresponding selection display on the whole corresponding track, and responding to subsequent editing operations such as deleting, moving, and copying; and
not performing corresponding selection display on the timeline track of the background music, and not responding to subsequent editing operations such as deleting, moving, and copying.

In some embodiments of the present application, the above track linkage logic during editing is default, and linkage switch controls may also be set for different timeline tracks, and the user may determine whether to link the corresponding timeline tracks through the trigger operation for the linkage switch controls, which is not limited here.

In some embodiments of the present application, the method provided by the embodiments of the present application may further include the following steps 201 to 202.

201, in response to a second trigger operation for selected text data in the text data to be processed, a tool menu is displayed in an area corresponding to the selected text data.

The tool menu includes at least one of the following: an editing control and an adding control, and the editing control includes at least one of the following: a deleting control corresponding to a deleting operation, a copying control corresponding to a copying operation, a cutting control corresponding to a cutting operation, and a modifying control corresponding to a modifying operation, an intelligent long and short sentence control, a searching control, and a replacing control, and the adding control includes at least one of the following: an adding picture in picture control, an adding non-subtitle text control, an adding sticker control, an adding effect control, an adding sound effect control, an adding filter control, an adding material package control, and an adding background music control.

Any of the above adding controls may support the user to manually select the addition or intelligently match the addition.

202, in response to a third trigger operation for a target control in the tool menu, corresponding processing is performed on at least one of the media videos, the text data to be processed, and the media audio.

In the embodiments of the present application, the tool menu may be displayed through the second trigger operation for the selected text data, and then the trigger operation for any control in the tool menu may be performed according to actual needs to perform corresponding editing processing, and the interaction operation is simple and convenient, which is beneficial to improving the user experience.

In some embodiments of the present application, the display area where the text data to be processed is located includes a material library control, which may perform text editing on the global video, and may also perform rough cutting on the content of the material library.

In some embodiments of the present application, after the above step 101, the method provided by the embodiments of the present application may further include the following steps 301 to 305.

301, in response to a trigger operation for the material library control, a plurality of preset video materials are displayed.

302, in response to a fifth trigger operation for a target video material in the plurality of preset video materials, a text rough cut floating window is displayed.

The text rough cut floating window includes material text data corresponding to the target video material, and the target video material includes a target material video and a target material audio, and there is a fourth mapping relationship between material time code information of the material text data and timeline information of the target material video, and there is a fifth mapping relationship between the material time code information and timeline information of the target material audio.

303, in response to a text rough cut operation for selected material text in the material text data, the selected material text is synthesized with the text data to be processed to obtain text data to be edited.

304, a material video clip is synthesized with the media video to obtain a media video to be edited.

305, a material audio clip is synthesized with the media audio to obtain a media audio to be edited, to implement editing a video to be edited based on a text editing operation for the text data to be edited.

The material video clip is a video clip which is obtained from the target material video and corresponds to the selected material text based on the fourth mapping relationship, and the material audio clip is an audio clip which is obtained from the target material audio and corresponds to the selected material text based on the fifth mapping relationship, and the video to be edited includes the media video to be edited and the media audio to be edited.

In the embodiments of the present application, the text editing panel may further include the material library control, and the plurality of preset video materials may be displayed through the trigger operation for the material library control, and the user may select the required target material video from the plurality of preset video materials according to needs, and then the text rough cut floating window is pulled up through the text rough cut operation for the target material video, and the material text data corresponding to the target material video is displayed in the rough cut floating window, therefore, the user may edit the material editing clip required by the user in the target material video through the text rough cut operation for the selected material text in the material text data to obtain the material video clip and the material audio clip, and then synthesize the selected material text with the text data to be processed to obtain the text data to be edited, synthesize the material video clip with the media video to obtain the media video to be edited, and synthesize the material audio clip with the media audio to obtain the media audio to be edited, to implement the editing of the video to be edited based on the text editing operation for the text data to be edited.

In the embodiments of the present application, the video to be processed may also be synthesized by selecting at least one material from the material library and then performing text rough cutting to obtain multiple material editing clips, which may be specifically determined according to the actual situation, and is not limited here.

In some embodiments of the present application, any material in the material library may be selected, and a right-click menu may be used to add a new text rough cut entry. Clicking on the text rough cut entry will bring up the text rough cut floating window, and at the same time, ASR recognition will be started on the selected material, which supports rough cutting the material in the text rough cut floating window to add it to the timeline.

The text rough cut floating window includes a floating window text preview area, and may also include a floating window video preview area, a floating window timeline display area, etc., which may specifically refer to the relevant description of the text editing panel, and may be determined according to the actual situation, and is not limited here.

The ASR recognition result (material text data) for the selected material will be displayed in the floating window text preview area. For the specific form of displaying the material text data in the floating window text preview area, reference may be made to the specific form of displaying the text data to be processed in the text preview area of the above text editing panel, which will not be repeated here.

Text rough cut operation: selecting material text, dragging the selected material text, and performing the rough cut operation, or selecting the material text, using the right button to call up the rough cut control, and clicking on the rough cut control, which may be specifically determined according to the actual situation, and is not limited here.

In some embodiments of the present application, for a local material intelligent search keyword, when a search result is selected and text rough cutting is being performed, the corresponding text is matched and selected by default and may be folded up to quickly complete rough cutting.

For input text data, a text rough cutting function through an editing floating window is supported. The text rough cut control may be called up through a trigger operation for the input text data or a matching video, and then a new modal window is called up through a trigger operation for the text rough cut control, which supports rough cutting the input text data in this panel and implements corresponding editing of the matching video. For the specific process, reference may be made to the above editing operation of the text data to be processed to implement the editing of the video to be processed, which will not be repeated here.

In the embodiments of the present application, the editing of the matching video corresponding to the input text data is implemented through the editing floating window, and the video to be processed after the editing processing and the matching video after the editing processing are synthesized to obtain the target edited video.

In some embodiments of the present application, different display objects may be displayed in different areas in the text editing panel. For example, the text editing panel may be composed of some or all of the following areas: a video preview area, a text preview area, a text editing menu area, a global function area, and a timeline track display area. The video preview area is used to display the video to be processed, the text preview area is used to display the text data to be processed, the text editing menu area is used to display the text editing menu, and the global function area is used to display the global function menu.

In some embodiments of the present application, when the text editing panel is pulled up, a default layout mode is adopted. Then, it is supported to determine the partitions that may be displayed in the text editing panel by selecting a preset layout mode (such as a mode menu of “work mode” and “panel view mode”), and it is also supported to independently select whether each partition is displayed (check->display; uncheck->hide. For example, each panel partition may be displayed/canceled to be displayed through “√/x” in a view menu.). Moreover, the panel partition may be dragged to make it float outside the editor. When the panel partition is dragged and restored, it may only be returned to the corresponding position in the default layout (that is, it cannot be adsorbed at will).

The text editing panel also includes “restore”, “full screen”, “minimize”, and “close” options.

The text preview area includes the text data to be processed, text time code information corresponding to the text data to be processed, and a time axis cursor. The text data to be processed includes text data corresponding to the speech of at least one user, and the text data to be processed includes at least one text paragraph (including a silent clip [ . . . ]). The time axis cursor is used to indicate the current playing progress corresponding to the video to be processed, and corresponds to the current playing time axis of the video to be processed, and the corresponding text word or text sentence is highlighted. The position of the time axis cursor and the highlighted text word or text sentence are updated in real time when the video to be processed is playing.

The text segmentation logic in the embodiments of the present application may perform segmentation according to the following priority order: the priority of manual text return segmentation is greater than the priority of speaker segmentation, the priority of speaker segmentation is greater than the priority of segmentation according to pause duration, and the priority of segmentation according to pause duration is greater than the priority of segmentation according to the number of words in a paragraph.

The silent clip logic in the embodiments of the present application may include: scheme 1: a mute clip greater than or equal to 1 s is regarded as a silent clip and displayed in the text preview area of the text editing panel; and scheme 2: a mute clip greater than or equal to 10 times the speech speed is regarded as a silent clip and displayed in the text preview area of the text editing panel.

The positioning jump logic in the embodiments of the present application may be that manual scrolling of the text area is unresponsive, and the jump is only performed when switching to select is clicked.

In the embodiments of the present application, the tool menu may be called up through the trigger operation for the selected text, and then the text editing mode may be entered through the trigger operation for any editing control in the tool menu or directly through the trigger operation for any editing control in the text editing menu to perform text and video editing.

The text data to be processed is in a preview state (which is the default state). At this time, there is a cursor at the playing time point and the current read text word or text sentence (whether paused or playing) is highlighted. At this time, the editing state may be entered through a trigger operation to modify the content. For example, through the trigger operation for a selection control, the current highlighted sentence is selected, and the editing state is entered.

When there is selected text in the text data to be processed, the editing state is entered, and the following operations may be performed: a deleting operation, an inserting xxx (such as a text template/picture in picture, etc.) operation, a modifying operation, a moving operation, a copying operation, etc.

Deleting operation: when text is selected, the tool menu is called up, the deleting control may be seen, the deleting control is selected, the selected text and the track content corresponding to the selected text (the specific track to be deleted depends on the track linkage logic) are deleted, and after the deletion is finished, the preview state is returned to.

Inserting xxx (such as a text template/picture in picture, etc.) operation: when text is selected, the tool menu is called up, an adding xxx control may be seen, a corresponding panel is pulled up to display optional materials of the packaging object that may be added for the user to select, or the material of the packaging object to be added may be intelligently matched according to the selected text, which may be specifically determined according to the actual situation, and is not limited here.

After the user manually selects any material or intelligently matches the material, the material will cover the start time code of the selected text with a new track. After the addition, the addition result is not displayed in any form in the text preview area, but is visible in the video preview area (video preview window, video player), so it may only be edited on the screen, and the insertion is still in the editing state when finished.

Moving operation: after the text is selected, long-press the selected area, and the selected text paragraph may be dragged to any position (not within a word), and the corresponding video clip will also move accordingly, and the editing state is still maintained after the movement is finished.

Copying operation: when the text is selected, the tool menu is called up, the copying control may be seen, the copying control is selected, the text and the track content (the specific track to be copied depends on the track linkage switch) are copied, and after the text and the track content are pasted to the selected text, the editing state is still maintained after the copying is finished.

Modifying operation: this operation is applied to the text data to be processed and the media audio, and if there is subtitle text, it will also be linked, and this operation is not applied to the media video. When the text is selected, the tool menu is called up, the modifying control may be seen, the input box is pulled up after selection, the full text of the text data to be processed enters the input box, and the current selected sentence is also selected by default. The result of this modifying operation is only applied to the text data to be processed and the media audio (subtitle text), and is not applied to the media video, so the response result of the modifying operation is as follows: inserting line break-subtitle is divided into two sentences; removing line break-subtitle is combined into one sentence; correcting typos, subtitle is modified accordingly, and sometimes the pronunciation of the media audio is modified accordingly; inputting new text-the video time code will not be extended, and the text modification result is only applied to the subtitle. The complete control on the input box is selected to end the modifying operation and return to the preview state, and the cursor is located at the last input position.

In the embodiments of the present application, the following global function operations may be performed in the text editing mode: a searching operation, a filler word removing operation, and a subtitle switch operation.

Searching operation: after entering the text editing mode, the searching control is selected, the search box is expanded, the search keyword is entered, confirmation is clicked, the matched text is highlighted, and the previous control and the next control are supported to be selected to quickly jump to the search result. The closing control in the search box is clicked to collapse the search box.

Filler word removing operation: after entering the text editing mode, the filler word removing control is selected to start identifying filler words, and after the filler word identification is completed, the filler words in the text preview area are highlighted, and a confirmation (filler word removing) control is added at the bottom, and the one-click filler word removing function may be implemented through the trigger operation for the confirmation control, and the user may confirm whether the filler word identification result is accurate, if it is inaccurate, a single filler word may be selected to call up the restoration control (to cancel the corresponding highlight mark), and if confirmed, the confirmation control may be selected to continue the follow-up operation. The confirmation control is selected to delete all the filler words highlighted and return to the text editing mode.

In some embodiments of the present application, the filler word removing operation will trigger full text filler words removal. If the filler words removal has been processed, the second click will respond to re-process it again.

Subtitle switch operation: the subtitle content is linked with the text content, and the subtitle switch control (which may include a subtitle enabling control and a subtitle disabling control) only controls whether the subtitle is visible. The subtitle enabling control is selected to add a subtitle, and when the text data is updated, the subtitle is necessarily updated in linkage; the subtitle disabling control is selected to avoid adding a subtitle.

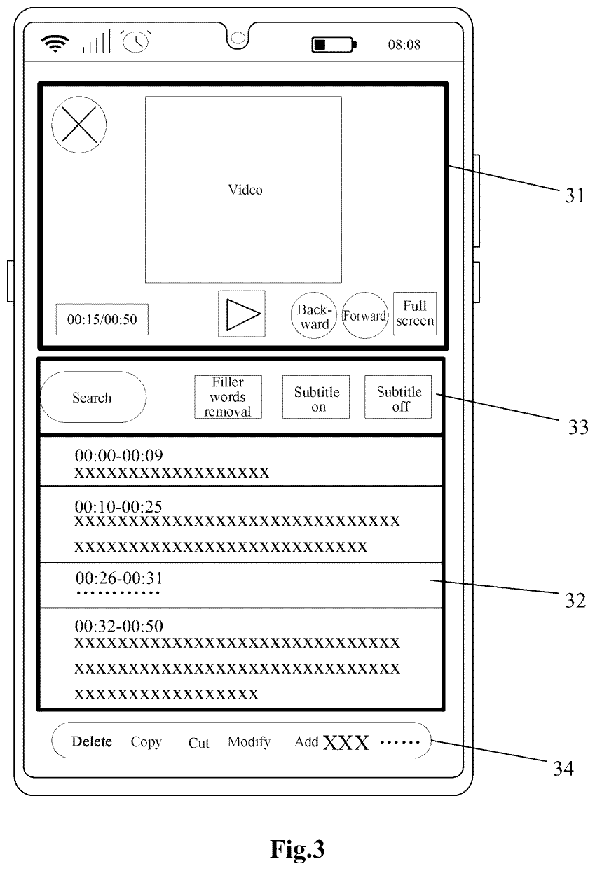

Example 1: since the display size of the mobile electronic device is limited and most of the mobile electronic devices correspond to non-professional users, for the mobile electronic device, the text editing panel may display the text preview area (corresponding to display the text data to be processed), the video preview area (corresponding to display the video to be processed), the text editing menu area (corresponding to display the text editing menu) and the global function area (corresponding to display the global function menu) as shown in FIG. 3 by default, where, the area marked with “31” is the video preview area, the area marked with “32” is the text preview area, the area marked with “33” is the global function area, and the area marked with “34” is the text editing menu area. The first timeline track, the second timeline track, and the timeline tracks corresponding to other packaging objects in the video to be processed may be controlled to be displayed accordingly in the text editing panel through corresponding trigger operations according to use requirements, which is not limited here.

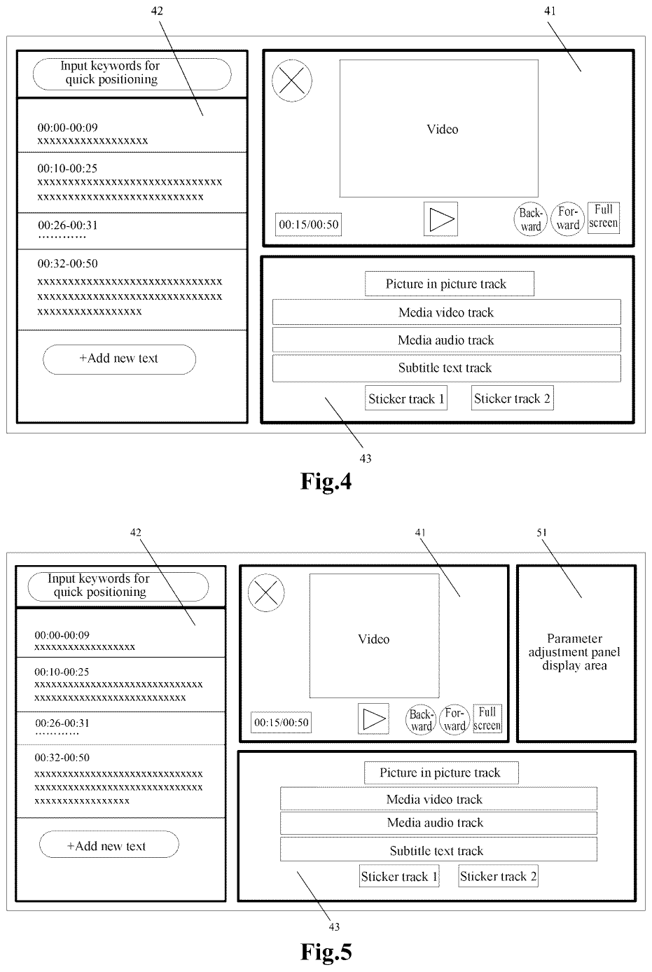

Example 2: for the non-mobile electronic device, the three-column layout mode of the text preview area, the video preview area and the timeline track display area as shown in FIG. 4 may be displayed by default, or the four-column layout mode of the text preview area, the video preview area, the timeline track display area and the parameter adjustment panel display area as shown in FIG. 5 may be displayed by default. The area marked with “41” is the video preview area, the area marked with “42” is the text preview area, the area marked with “43” is the timeline track display area, and the area marked with “51” is the parameter adjustment panel display area.

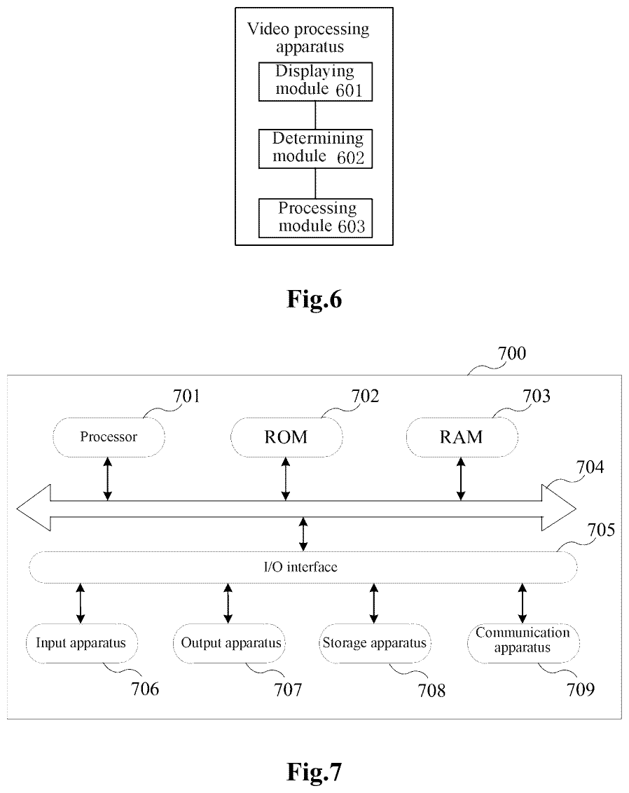

FIG. 6 is a structural block diagram of a video processing apparatus according to an embodiment of the present disclosure, and as shown in FIG. 6, the apparatus includes:
a displaying module 601, configured to display text data to be processed corresponding to a video to be processed, where the video to be processed includes a media video and a media audio, and there is a first mapping relationship between text time code information corresponding to the text data to be processed and first timeline information corresponding to the media video, and there is a second mapping relationship between the text time code information and second timeline information corresponding to the media audio; a determining module 602, configured to, in response to a first trigger operation for target text data in the text data to be processed, determine a target video clip corresponding to the target text data from the media video based on the first mapping relationship; the determining module 602 is further configured to determine a target audio clip corresponding to the target text data from the media audio based on the second mapping relationship; and a processing module 603, configured to perform corresponding processing on the target text data, the target video clip, and the target audio clip based on the first trigger operation.

In some embodiments of the present application, the video to be processed further includes at least one packaging object, and there is a mapping relationship between the text time code information and timeline information corresponding to each packaging object, where an object type of each packaging object includes at least one of the following: subtitle text, picture in picture, non-subtitle text, sticker, effect, filter, material package, and background music.

In some embodiments of the present application, the first trigger operation includes any of the following: a deleting operation, a dragging operation, a copying operation, and a cutting operation, and the determining module 602 is further configured to, in response to the first trigger operation for the target text data in the text data to be processed, determine a target packaging object corresponding to the target text data from the at least one packaging object, and the processing module 603 is further configured to, based on the first trigger operation, in a case that an object type of the target packaging object is any of a first type, perform corresponding processing on the target packaging object, and in a case that the object type of the target packaging object is any of a second type, prohibit performing corresponding processing on the target packaging object, where the first type includes at least one of the following: subtitle text, picture in picture, non-subtitle text, sticker, effect, filter, and material package, and the second type includes: background music.

In some embodiments of the present application, the first type includes a third type and a fourth type, and the processing module 603 is further configured to, in a case that the object type of the target packaging object is any of the third type, perform corresponding processing on a target packaging clip in the target packaging object, where the target packaging clip is a part corresponding to the target text data in the target packaging object; or in a case that the object type of the target packaging object is any of the fourth type and a start time stamp of the target packaging object is within a time code range corresponding to the target text data, perform corresponding processing on the whole target packaging object, where the third type includes at least one of the following: subtitle text and picture in picture, and the fourth type includes at least one of the following: non-subtitle text, sticker, effect, filter, and material package.

In some embodiments of the present application, the processing module 603 is further configured to: in the case that the object type of the target packaging object is any of the fourth type and the start time stamp of the target packaging object is not within the time code range corresponding to the target text data, prohibit performing corresponding processing on the target packaging object.

In some embodiments of the present application, the apparatus further includes: an acquiring module, a generating module, and a replacing module, and the acquiring module is configured to, in response to a modifying operation for first text data in the text data to be processed, acquire modified second text data corresponding to the modifying operation, and the determining module 602 is further configured to determine a first audio clip corresponding to the first text data from the media audio based on the second mapping relationship, and the generating module is configured to generate a second audio clip based on the second text data and tone information of the first audio clip, and the replacing module is configured to replace the first audio clip in the media audio with the second audio clip.

In some embodiments of the present application, the video to be processed further includes subtitle text, and there is a third mapping relationship between the text time code information and third timeline information corresponding to the subtitle text, and the apparatus further includes: a modifying module and a replacing module, and the determining module 602 is further configured to, in response to a modifying operation for first text data in the text data to be processed, determine a first subtitle clip corresponding to the first text data from the subtitle text based on the third mapping relationship, and the modifying module is configured to modify the first subtitle clip based on second text data to obtain a second subtitle clip, and the replacing module is configured to replace the first subtitle clip in the subtitle text with the second subtitle clip.

In some embodiments of the present application, the first trigger operation further includes a selecting operation, and the displaying module 601 is further configured to, before in response to the first trigger operation for the target text data in the text data to be processed, determining the target video clip corresponding to the target text data from the media video based on the first mapping relationship, display a first timeline track and a second timeline track, where the first timeline track is a timeline track corresponding to the media video, and the second timeline track is a timeline track corresponding to the media audio, and the processing module 603 is further configured to display the target text data according to a first display style, display a part corresponding to the target video clip in the first timeline track according to a second display style, and display a part corresponding to the target audio clip in the second timeline track according to a third display style.

In some embodiments of the present application, the displaying module 601 is further configured to, in response to a second trigger operation for selected text data in the text data to be processed, display a tool menu in an area corresponding to the selected text data, where the tool menu includes at least one of the following: an editing control and an adding control, and the editing control includes at least one of the following: a deleting control corresponding to a deleting operation, a copying control corresponding to a copying operation, a cutting control corresponding to a cutting operation, and a modifying control corresponding to a modifying operation, an intelligent long and short sentence control, a searching control, and a replacing control, and the adding control includes at least one of the following: an adding picture in picture control, an adding non-subtitle text control, an adding sticker control, an adding effect control, an adding sound effect control, an adding filter control, an adding material package control, and an adding background music control, and the processing module 603 is further configured to, in response to a third trigger operation for a target control in the tool menu, perform corresponding processing on at least one of the media video, the text data to be processed, and the media audio.

In some embodiments of the present application, the apparatus further includes: a synthesizing module, and the displaying module 601 is configured to, after displaying the text data to be processed corresponding to the video to be processed, in response to a trigger operation for a material library control, display a plurality of preset video materials, and in response to a fifth trigger operation for a target video material in the plurality of preset video materials, display a text rough cut floating window, where the text rough cut floating window includes material text data corresponding to the target video material, and the target video material includes a target material video and a target material audio, and there is a fourth mapping relationship between material time code information of the material text data and timeline information of the target material video, and there is a fifth mapping relationship between the material time code information and timeline information of the target material audio, and the synthesizing module is configured to, in response to a text rough cut operation for selected material text in the material text data, synthesize the selected material text with the text data to be processed to obtain text data to be edited, synthesize a material video clip with the media video to obtain a media video to be edited, and synthesize a material audio clip with the media audio to obtain a media audio to be edited, to implement editing a video to be edited based on a text editing operation for the text data to be edited, where the material video clip is a video clip which is obtained from the target material video and corresponds to the selected material text based on the fourth mapping relationship, and the material audio clip is an audio clip which is obtained from the target material audio and corresponds to the selected material text based on the fifth mapping relationship, and the video to be edited includes the media video to be edited and the media audio to be edited.

In the embodiments of the present disclosure, each module may implement the video processing method provided by the above method embodiments, and may achieve the same technical effects, and to avoid repetition, details are not repeated here.

FIG. 7 is a schematic structural diagram of an electronic device provided by an embodiment of the present disclosure, which is used to exemplarily illustrate the electronic device that implements any video processing method in the embodiments of the present disclosure, and should not be understood as a specific limitation to the embodiments of the present disclosure.

As shown in FIG. 7, the electronic device 700 may include a processor (such as a central processing unit, a graphics processing unit, etc.) 701, which may perform various appropriate actions and processing according to a program stored in a read-only memory (ROM) 702 or a program loaded from a storage apparatus 708 into a random access memory (RAM) 703. The RAM 703 further stores various programs and data required for the operation of the electronic device 700. The processor 701, the ROM 702, and the RAM 703 are connected to each other through a bus 704. An input/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape, and a hard disk; and a communication apparatus 709. The communication apparatus 709 may allow the electronic device 700 to perform wireless or wired communication with other devices to exchange data. Although the electronic device 700 having various apparatuses is shown, it should be understood that not all the apparatuses shown here need to be implemented or provided. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program codes for performing the method shown in the flowchart. In such an embodiment, the computer program may be downloaded and installed from a network through the communication apparatus 709, or installed from the storage apparatus 708, or installed from the ROM 702. When the computer program is executed by the processor 701, the functions defined in any video processing method provided by the embodiments of the present disclosure may be executed.

It should be noted that the above computer-readable medium in the present disclosure may be a computer-readable signal medium or a computer-readable storage medium or any combination of the two. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as a part of a carrier wave, and computer-readable program codes are carried in the data signal. The data signal propagated in this way may adopt multiple forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus or device. The program codes contained on the computer-readable medium may be transmitted by any suitable medium, including but not limited to: a wire, an optical cable, an RF (radio frequency), etc., or any suitable combination of the above.

In some implementations, the client and the server may communicate using any currently known or future developed network protocol, such as the HTTP (HyperText Transfer Protocol), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above computer-readable medium may be included in the above electronic device, or it may exist alone without being assembled into the electronic device.

The above computer-readable medium carries one or more programs, and when the one or more programs are executed by the electronic device, the electronic device is caused to: display text data to be processed corresponding to a video to be processed, where the video to be processed includes a media video and a media audio, and there is a first mapping relationship between text time code information corresponding to the text data to be processed and first timeline information corresponding to the media video, and there is a second mapping relationship between the text time code information and second timeline information corresponding to the media audio; in response to a first trigger operation for target text data in the text data to be processed, determine a target video clip corresponding to the target text data from the media video based on the first mapping relationship; determine a target audio clip corresponding to the target text data from the media audio based on the second mapping relationship; and perform corresponding processing on the target text data, the target video clip, and the target audio clip based on the first trigger operation.

In the embodiments of the present disclosure, the computer program codes used to perform the operations of the present disclosure may be written in one or more programming languages or a combination thereof, and the above programming languages include but are not limited to object-oriented programming languages, such as Java, Smalltalk, and C++, and further include conventional procedural programming languages, such as “C” language or similar programming languages. The program codes may be executed entirely on a computer, partly on the computer, as a stand-alone software package, partly on the computer and partly on a remote computer, or entirely on the remote computer or a server. In the case of involving the remote computer, the remote computer may be connected to the computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and the combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented in a software manner or in a hardware manner. The name of the unit does not constitute a limitation on the unit itself under certain circumstances.

The functions described above may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and more.

In the context of the present disclosure, the computer-readable medium may be a tangible medium that may contain or store programs for use by or in combination with an instruction execution system, apparatus or device. The computer-readable medium may be a computer-readable signal medium or a computer-readable storage medium. The computer-readable medium may include, but is not limited to, an electronic, magnetic, optical, electromagnetic, infrared, or semiconductor system, apparatus or device, or any suitable combination of the above. More specific examples of the computer-readable storage medium may include: an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description only illustrates preferred embodiments of the present disclosure and applied technical principles. Those skilled in the art should understand that the scope of disclosure involved in the present disclosure is not limited to the technical solutions formed by the specific combination of the above technical features, but also covers other technical solutions formed by any combination of the above technical features or their equivalent features without departing from the above disclosure concept. For example, the above features and the technical features provided in the present disclosure (but not limited to) with similar functions are replaced each other to form a technical solution.

Additionally, although operations are depicted in a specific order, this should not be understood as requiring that such operations are performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only exemplary forms of implementing the claims.

1. A video processing method, comprising:
displaying text data corresponding to a video, wherein the video t comprises a media video and a media audio, and there is a first mapping relationship between text time code information corresponding to the text data and first timeline information corresponding to the media video, and there is a second mapping relationship between the text time code information and second timeline information corresponding to the media audio;
determining, in response to a first trigger operation for target text data in the text data, a target video clip corresponding to the target text data from the media video based on the first mapping relationship;
determining a target audio clip corresponding to the target text data from the media audio based on the second mapping relationship; and
performing, based on the first trigger operation, corresponding processing on the target text data, the target video clip, and the target audio clip.

2. The method of claim 1, wherein the video further comprises at least one packaging object, and there is a mapping relationship between the text time code information and timeline information corresponding to each packaging object;
wherein an object type of each packaging object comprises at least one of the following:
subtitle text, picture in picture, non-subtitle text, sticker, effect, filter, material package, or background music.

3. The method of claim 2, wherein the first trigger operation comprises any of the following:
a deleting operation, a dragging operation, a copying operation, or a cutting operation; and
the method further comprising:
determining, in response to the first trigger operation for the target text data in the text data, a target packaging object corresponding to the target text data from the at least one packaging object;
performing, based on the first trigger operation and in a case that an object type of the target packaging object is any of a first type, corresponding processing on the target packaging object; and
prohibiting, in a case that the object type of the target packaging object is any of a second type, performing corresponding processing on the target packaging object; and
wherein the first type comprises at least one of the following: subtitle text, picture in picture, non-subtitle text, sticker, effect, filter, or material package; and
the second type comprises: background music.

4. The method of claim 3, wherein the first type comprises a third type and a fourth type;
performing corresponding processing on the target packaging object in the case that the object type of the target packaging object is any of the first type comprises:
performing, in a case that the object type of the target packaging object is any of the third type, corresponding processing on a target packaging clip in the target packaging object, wherein the target packaging clip is a part corresponding to the target text data in the target packaging object; or
performing, in a case that the object type of the target packaging object is any of the fourth type and a start time stamp of the target packaging object is within a time code range corresponding to the target text data, corresponding processing on the whole target packaging object; and
wherein the third type comprises at least one of the following: subtitle text or picture in picture; and
the fourth type comprises at least one of the following: non-subtitle text, sticker, effect, filter, or material package.

5. The method of claim 4, further comprising:
prohibiting, in a case that the object type of the target packaging object is any of the fourth type and the start time stamp of the target packaging object is not within the time code range corresponding to the target text data, performing corresponding processing on the target packaging object.

6. The method of claim 1, further comprising:
acquiring, in response to a modifying operation for first text data in the text data, modified second text data corresponding to the modifying operation;
determining a first audio clip corresponding to the first text data from the media audio based on the second mapping relationship;
generating a second audio clip based on the second text data and tone information of the first audio clip; and
replacing the first audio clip in the media audio with the second audio clip.

7. The method of claim 6, wherein the video further comprises subtitle text, and there is a third mapping relationship between the text time code information and third timeline information corresponding to the subtitle text, and the method further comprises:
determining a first subtitle clip corresponding to the first text data from the subtitle text based on the third mapping relationship, in response to the modifying operation for the first text data in the text data;
modifying the first subtitle clip based on the second text data to obtain a second subtitle clip; and
replacing the first subtitle clip in the subtitle text with the second subtitle clip.

8. The method of claim 1, wherein the first trigger operation further comprises a selecting operation, and before determining, in response to the first trigger operation for the target text data in the text data, the target video clip corresponding to the target text data from the media video based on the first mapping relationship, the method further comprises:
displaying a first timeline track and a second timeline track, wherein the first timeline track is a timeline track corresponding to the media video, and the second timeline track is a timeline track corresponding to the media audio; and
performing corresponding processing on the target text data, the target video clip, and the target audio clip based on the first trigger operation comprises:
displaying the target text data based on a first display style;
displaying a part corresponding to the target video clip in the first timeline track based on a second display style; and
displaying a part corresponding to the target audio clip in the second timeline track based on a third display style.

9. The method of claim 1, further comprising:
displaying, in response to a second trigger operation for selected text data in the text data, a tool menu in an area corresponding to the selected text data, wherein the tool menu comprises at least one of the following: an editing control or an adding control, and the editing control comprises at least one of the following: a deleting control corresponding to a deleting operation, a copying control corresponding to a copying operation, a cutting control corresponding to a cutting operation, and a modifying control corresponding to a modifying operation, an intelligent long and short sentence control, a searching control, or a replacing control, and the adding control comprises at least one of the following: an adding picture in picture control, an adding non-subtitle text control, an adding sticker control, an adding effect control, an adding sound effect control, an adding filter control, an adding material package control, or an adding background music control; and
performing, in response to a third trigger operation for a target control in the tool menu, corresponding processing on at least one of the media video, the text data, or the media audio.

10. The method of claim 1, wherein after displaying the text data corresponding to the video, the method further comprises:
displaying, in response to a trigger operation for a material library control, a plurality of preset video materials;
displaying, in response to a fifth trigger operation for a target video material in the plurality of preset video materials, a text rough cut floating window, wherein the text rough cut floating window comprises material text data corresponding to the target video material, and the target video material comprises a target material video and a target material audio, and there is a fourth mapping relationship between material time code information of the material text data and timeline information of the target material video, and there is a fifth mapping relationship between the material time code information and timeline information of the target material audio; and
synthesizing, in response to a text rough cut operation for selected material text in the material text data, the selected material text with the text data to obtain third text data, synthesizing a material video clip with the media video to obtain a first media video, and synthesizing a material audio clip with the media audio to obtain a first media audio, to implement editing a first video based on a text editing operation for the third text data; and
wherein the material video clip is a video clip which is obtained from the target material video and corresponds to the selected material text based on the fourth mapping relationship, and the material audio clip is an audio clip which is obtained from the target material audio and corresponds to the selected material text based on the fifth mapping relationship, and the first video comprises the first media video and the first media audio.

12. An electronic device, comprising: a memory and a processor, wherein the memory is configured to store a computer program, and the processor is configured to, when invoking the computer program, cause the device to:
display text data corresponding to a video, wherein the video comprises a media video and a media audio, and there is a first mapping relationship between text time code information corresponding to the text data and first timeline information corresponding to the media video, and there is a second mapping relationship between the text time code information and second timeline information corresponding to the media audio;
determine, in response to a first trigger operation for target text data in the text data, a target video clip corresponding to the target text data from the media video based on the first mapping relationship;
determine a target audio clip corresponding to the target text data from the media audio based on the second mapping relationship; and
perform corresponding processing on the target text data, the target video clip, and the target audio clip based on the first trigger operation.

13. A non-transitory computer-readable storage medium having a computer program stored thereon, and when the computer program is executed by a processor, the processor causes a computer to:
display text data corresponding to a video, wherein the video comprises a media video and a media audio, and there is a first mapping relationship between text time code information corresponding to the text data and first timeline information corresponding to the media video, and there is a second mapping relationship between the text time code information and second timeline information corresponding to the media audio;
determine, in response to a first trigger operation for target text data in the text data, a target video clip corresponding to the target text data from the media video based on the first mapping relationship;
determine a target audio clip corresponding to the target text data from the media audio based on the second mapping relationship; and
perform corresponding processing on the target text data, the target video clip, and the target audio clip based on the first trigger operation.

14. The electronic device according to claim 12, wherein the video further comprises at least one packaging object, and there is a mapping relationship between the text time code information and timeline information corresponding to each packaging object;
wherein an object type of each packaging object comprises at least one of the following:
subtitle text, picture in picture, non-subtitle text, sticker, effect, filter, material package, or background music.

15. The electronic device according to claim 14, wherein the first trigger operation comprises any of the following:
a deleting operation, a dragging operation, a copying operation, or a cutting operation; and
the processor further causes the device to:
determine, in response to the first trigger operation for the target text data in the text data, a target packaging object corresponding to the target text data from the at least one packaging object;
perform, based on the first trigger operation and in a case that an object type of the target packaging object is any of a first type, corresponding processing on the target packaging object; and
prohibit, in a case that the object type of the target packaging object is any of a second type, performing corresponding processing on the target packaging object; and
wherein the first type comprises at least one of the following: subtitle text, picture in picture, non-subtitle text, sticker, effect, filter, or material package; and
the second type comprises: background music.

16. The electronic device according to claim 15, wherein the first type comprises a third type and a fourth type;
the processor performing corresponding processing on the target packaging object in the case that the object type of the target packaging object is any of the first type further causes the device to:
perform, in a case that the object type of the target packaging object is any of the third type, corresponding processing on a target packaging clip in the target packaging object, wherein the target packaging clip is a part corresponding to the target text data in the target packaging object; or
perform, in a case that the object type of the target packaging object is any of the fourth type and a start time stamp of the target packaging object is within a time code range corresponding to the target text data, corresponding processing on the whole target packaging object; and
wherein the third type comprises at least one of the following: subtitle text or picture in picture; and
the fourth type comprises at least one of the following: non-subtitle text, sticker, effect, filter, or material package.

17. The electronic device according to claim 16, wherein the processor further causes the device to:
prohibit, in a case that the object type of the target packaging object is any of the fourth type and the start time stamp of the target packaging object is not within the time code range corresponding to the target text data, performing corresponding processing on the target packaging object.

18. The electronic device according to claim 12, wherein the processor further causes the device to:
acquire, in response to a modifying operation for first text data in the text data, modified second text data corresponding to the modifying operation;
determine a first audio clip corresponding to the first text data from the media audio based on the second mapping relationship;
generate a second audio clip based on the second text data and tone information of the first audio clip; and
replace the first audio clip in the media audio with the second audio clip.

19. The electronic device according to claim 18, wherein the video further comprises subtitle text, and there is a third mapping relationship between the text time code information and third timeline information corresponding to the subtitle text, and the processor further causes the device to:
determine a first subtitle clip corresponding to the first text data from the subtitle text based on the third mapping relationship, in response to the modifying operation for the first text data in the text data;
modify the first subtitle clip based on the second text data to obtain a second subtitle clip; and
replace the first subtitle clip in the subtitle text with the second subtitle clip.

20. The electronic device according to claim 12, wherein the first trigger operation further comprises a selecting operation, and before the processor causing the device to determine, in response to the first trigger operation for the target text data in the text data, the target video clip corresponding to the target text data from the media video based on the first mapping relationship, the processor further causes the device to:
display a first timeline track and a second timeline track, wherein the first timeline track is a timeline track corresponding to the media video, and the second timeline track is a timeline track corresponding to the media audio; and
the processor causing the device to perform corresponding processing on the target text data, the target video clip, and the target audio clip based on the first trigger operation further causes the device to:
display the target text data based on a first display style;
display a part corresponding to the target video clip in the first timeline track based on a second display style; and
display a part corresponding to the target audio clip in the second timeline track based on a third display style.

21. The electronic device according to claim 12, wherein the processor further causes the device to:
display, in response to a second trigger operation for selected text data in the text data, a tool menu in an area corresponding to the selected text data, wherein the tool menu comprises at least one of the following: an editing control or an adding control, and the editing control comprises at least one of the following: a deleting control corresponding to a deleting operation, a copying control corresponding to a copying operation, a cutting control corresponding to a cutting operation, and a modifying control corresponding to a modifying operation, an intelligent long and short sentence control, a searching control, or a replacing control, and the adding control comprises at least one of the following: an adding picture in picture control, an adding non-subtitle text control, an adding sticker control, an adding effect control, an adding sound effect control, an adding filter control, an adding material package control, or an adding background music control; and
perform, in response to a third trigger operation for a target control in the tool menu, corresponding processing on at least one of the media video, the text data, or the media audio.
